(19) United States
(12) Patent Application Publication
(10) Pub. No.: US 2009/0022824 A1
(43) Pub. Date: Jan. 22, 2009

(54) Pesticidal formulations

(75) Inventor: Prem Chand Akhil, Queensland (AU)

Correspondence Address: STOUT, UXA, BUYAN & MULLINS LLP, 4 VENTURE, SUITE 300, IRVINE, CA, 92618, US

(73) Assignee: Akhil Technologies Pty Ltd, Aspley (AU)

(21) Appl. No.: 11/919,959

(22) PCT Filed: May 3, 2006
(86) PCT No.: PCT/AU2006/000581

§ 371 Date: Nov. 1, 2007

(30) Foreign Application Priority Data
May 3, 2005 (AU) 2005902218

(51) Int. Cl. A01N 65/00; A01N 47/46; A01P 7/04; A01P 15/00

(52) U.S. Cl. 424/740; 514/515; 424/725

(57) ABSTRACT

The present invention discloses formulations that are effective for controlling pests. More particularly, the present invention discloses the use of at least one phenol and at least one isothiocyanate in methods and formulations for increasing the mortality or decreasing the growth of pests or for repelling pests.

### FIELD OF INVENTION

This invention generally relates to pesticidal formulations, as well as methods for their manufacture, and use.

### BACKGROUND OF THE INVENTION

Environmental pollution including soil and water pollution resulting from extensive spray of various synthetic pesticides has been recognised as a serious environmental problem. As a result, there is an interest in developing pesticides with lower environmental toxicity. In particular, the development of natural pesticides that are less harmful to humans whilst still maintaining suitable pesticidal activity is of interest.

Due to indeterminate storage conditions, chemical formulations frequently require a certain inherent stability. The long- or short-term stability of many chemical formulations relies on the susceptibility of the formulation to degradative chemical reactions and processes. Degradation of a chemical formulation depends, for example, on the length of storage time, storage temperature, exposure to light, and chemical reactions such as oxidation.

Chemical degradation of chemical formulations can result in rancidity, and instability and breakdown of active components and other constituents of the formulation. For example, the oxidation of the lipids by the free radical chain reaction may cause rancidity in a lipid containing formulation.

Due to the nature and magnitude of the persisting chemical residues associated with many current pesticidal formulations, increase in the resistance of many pests, together with high toxicity levels of many chemical pesticides, there is a need for alternative pesticidal formulations and approaches to pest control.

### SUMMARY OF THE INVENTION

The present invention relates to compounds, which in combination are suitable for use in pesticidal formulations, to the formulations themselves, and to the various applications of those formulations as pesticides.

Accordingly, in one aspect, the invention provides a pesticidal formulation comprising one or more phenols and one or more isothiocyanates.

In some embodiments, the weight ratio of phenol component(s) to isothiocyanate component(s) is in the range of about 1:95 to about 4:1; and in other embodiments from about 1:4 to about 1:1.

In even further embodiments, the weight ratio of phenol to isothiocyanate is from about 1:2.3 to about 1:1.3.

In some embodiments, the pesticidal formulation may be in the form of a concentrate.

In some embodiments, the pesticidal formulation further comprises a carrier which may be a carrier oil.

The pesticidal formulation may be in the form of a solution, a suspension, or an emulsion, and may be in the form of a concentrate, a concentrate partially diluted in a carrier, or in a diluted ready to apply formulation.

The pesticidal formulation may further comprise one or more surfactants, dispersants, detergents, stabilisers, emulsifiers, wetting agents, spreading agents, sticking agents, colorants, foam suppressants or drift suppressants.

In some embodiments, the pesticidal formulation further comprises a curcuminoid. The curcuminoid may be included in the formulation in the form of tumeric oil.

The pesticidal formulation may further comprise anethole. The anethole may be in the form of anise oil.

In another aspect, the present invention resides in a pesticidal formulation comprising about 5% to about 25% by weight of oregano oil; about 10% to about 80% by weight of allyl isothiocyanate; about 5% to about 25% by weight of turmeric oil; about 5% to about 25% by weight of ajowan oil; and about 5% to about 25% by weight of star anise oil.

In a further specific embodiments, the pesticidal formulation comprises by weight about 5% oregano oil; about 10% allyl isothiocyanate; about 5% turmeric oil; about 5% ajowan oil; about 5% star anise oil, and about 70% canola oil which is suitably emulsifiable.

In specific embodiments, the pesticidal formulation is further dissolved in a suitable carrier oil.

In one embodiments the pesticidal formulation may be in the form of a soil pesticidal formulation. In another embodiment the pesticidal formulation may be in the form of a plant pesticidal formulation.

In yet another aspect, the invention resides in a method of treating pest infestations, the method comprising applying a pesticidally effective amount of a formulation according to the invention, to a location in need of treatment for pest infestations.

In still another aspect, the invention resides in the use of one or more phenols and one or more isothiocyanates, in the manufacture of a pesticidal composition for treating pest infestations.

### BRIEF DESCRIPTION OF THE DRAWINGS

In order that the present invention can be more readily understood and put into practical effect, reference will now be made to the accompanying drawings wherein:

FIG. 1 is a graphical representation of a gall-rating index of tomato plants grown in root-knot nematode inoculated soil treated with three rates of pesticidal formulation (A1-1, A1-2, and A1-3), metham sodium and left untreated;

FIG. 2 is a graphical representation of a recovery of juvenile root-knot nematodes from the roots of tomato plants grown root-knot nematode inoculated soil treated with three rates of pesticidal formulation (A1-1, A1-2, and A1-3), metham sodium and left untreated;

FIG. 3 is graphical representation of a determination of the LD 50 of the pesticidal formulation for the control of root-knot nematodes in a pot trial comparing three rates of pesticidal formulation to metham sodium and an untreated control;

FIG. 4 is a photographic representation showing club root infection damage of broccoli with and without treatment with pesticidal formulation (A1-1);

FIG. 5 is a photographic representation of treated plants after 39 days of sowing and with different treatments;

FIG. 6 is a photographic representation of treated plants comparing their root length and with different treatments;

FIG. 7 is a graphical representation showing measurement of club root infection of plants following different treatments;

FIG. 8 is a graphical representation showing measurement of soft root infection infection of plants following different treatments; and

FIG. 9 is a graphical representation showing length of tap roots following different treatments.

### DETAILED DESCRIPTION OF THE PREFERRED EMBODIMENTS

By “about” is meant a quantity, level, value, number, frequency, percentage, dimension, size, amount, weight or length that varies by as much as 30, 25, 20, 25, 10, 9, 8, 7, 6, 5, 4, 3, 2 or 1% to a reference quantity, level, value, number, frequency, percentage, dimension, size, amount, weight or length.

As used herein, the terms “C₁₋₄aldehyde” and “C₁₋₄alkanal” refer to a straight chain or branched, aromatic or aliphatic, saturated or unsaturated alkanal groups having from 1 to 4 carbon atoms. Examples of C₁₋₄aldehyde include ethanal, propanal, and butanal.

As used herein, the term “C₁₋₄alkanoyl” refers to straight chain or branched, aromatic or aliphatic, saturated or unsaturated acyl groups having from 1 to 10 carbon atoms. Examples of C₁₋₁₀acyl include formyl, acetyl, propionyl, butanoyl, pentanoyl, pivaloyl, benzoyl and 2-phenylacetyl, Similarly, C₁₋₆, C₁₋₈ and C₁₋₁₀ acyl refer to groups having 1 to 4, 1 to 6, and 1 to 8 carbon atoms, respectively.

As used herein, the term “C₂₋₈alkenyl” refers to groups formed from C₂₋₈ straight chain, branched or cyclic alkenes. Examples of C₂₋₈alkenyl include allyl, 1-methylvinyl, butenyl, iso-butenyl, 3-methyl-2-butenyl, 1-pentenyl, cyclopentenyl, 1-methyl-cyclopentenyl, 1-hexenyl, 3-hexenyl, cyclohexenyl, 1,3-butadienyl, 1-4,pentadienyl, 1,3-cyclopentadienyl, 1,3-hexadienyl, 1,4-hexadienyl, 1,3-cyclohexadienyl and 1,4-cyclohexadienyl. Similarly, C₂₋₄, C₂₋₆ and C₂₋₁₀ alkenyl, for example, refer to groups having 2 to 4, 2 to 6, and 2 to 10 carbon atoms, respectively.

As used herein, the terms “C₁₋₆alkoxy” and “C₁₋₆alkyloxy” refer to straight chain or branched alkoxy groups having from 1 to 6 carbon atoms. Examples of C₁₋₆alkoxy include methoxy, ethoxy, n-propoxy, isopropoxy, and the different butoxy isomers. Similarly C₁₋₄, C₁₋₈ and C₁₋₁₀ alkoxy refer to groups having 1 to 4, 1 to 8, and 1 to 10 carbon atoms, respectively.

As used herein the term “C₁₋₁₀alkyl” refers to as used alone or as part of a group such as “di(C₁₋₁₀alkyl)amino” refers to straight chain, branched or cyclic alkyl groups having from 1 to 6 carbon atoms. Examples of such alkyl groups include methyl, ethyl, n-propyl, isopropyl, n-butyl, cyclopentyl and cyclohexyl. Similarly, C₁₋₄, C₁₋₆ and C₁₋₈ alkyl, for example, refer to groups having 1 to 4, 1 to 6, and 1 to 8 carbon atoms, respectively.

As used herein, the term “anti-foaming agent” refers to a substance that can eliminate or substantially reduce the excess foam that can result from certain herbicide mixtures undergo mixing or agitation, such as in a spray tank. Prevention of foam formation can be achieved, for example, by the use of organosilicon oligomer, such as disiloxane.

As used herein, the term “aqueous dispersion” refers to any mixture of two phases wherein dispersed particles are distributed homogeneously in a dispersant phase (dispergens), which in the instant case is water. The term aqueous dispersion is defined within the limits of so-called solid/liquid or liquid/liquid disperse systems, e.g. emulsion, dispersion, as opposed to other types of dispersions, such as solid/gas, e.g. fumes, or gas/liquid, e.g. foams, dispersions. Liquid/liquid dispersions are commonly defined as emulsions and consist of two separate phases of different polarity. In the instant case a non-polar phase is dispersed in the polar phase, which is suitably water.

As used herein, the term “aryl” refers to optionally substituted monocyclic, bicyclic, and biaryl carbocyclic aromatic groups, of 6 to 14 carbon atoms, covalently attached at any ring position capable of forming a stable covalent bond, certain preferred points of attachment being apparent to those skilled in the art. Examples of monocyclic aromatic groups include phenyl, toluoyl, xylyl and the like, each of which may be optionally substituted with C₁₋₆acyl, C₁₋₆alkyl, C₁₋₆alkoxy, C₂₋₆alkenyl, C₂₋₆alkynyl, C₁₋₆alkylsulphonyl, arylsulphonyl, C₁₋₆alkylsulphonamido, arylsulphonamido, halo, hydroxy, mercapto, trifluoromethyl, carbamoyl, amino, azido, nitro, cyano, C₁₋₆alkylamino or di(C₁₋₆alkyl)amino. Examples of bicyclic aromatic groups include 1-naphthyl, 2-naphthyl, indenyl and the like, each of which may be optionally substituted with C₁₋₆acyl, C₁₋₆alkyl, C₁₋₆alkoxy, C₂₋₆alkenyl, C₂₋₆alkynyl, C₁₋₆alkylsulphonyl, arylsulphonyl, C₁₋₆alkylsulphonamido, arylsulphonamido, halo, hydroxy, mercapto, trifluoromethyl, carbamoyl, amino, azido, nitro, cyano, C₁₋₆alkylamino or di(C₁₋₆alkyl)amino. Examples of biaryl aromatic groups include biphenyl, fluorenyl and the like, each of which may be optionally substituted with C₁₋₆acyl, C₁₋₆alkyl, C₁₋₆alkoxy, C₂₋₆alkenyl, C₂₋₆alkynyl, C₁₋₆alkylsulphonyl, arylsulphonyl, C₁₋₆alkylsulphonamido, arylsulphonamido, halo, hydroxy, mercapto, trifluoromethyl, carbamoyl, amino, azido, nitro, cyano, C₁₋₆alkylamino or di(C₁₋₆alkyl)amino.

As used herein, the term “arylC₁₋₄alkyl” refers to groups formed from C₁₋₄ straight chain or branched alkyl groups substituted with an aromatic ring. Examples of C₁₋₄alkylaryl include phenylmethyl (benzyl), phenylethyl (phenethyl), phenylpropyl and phenylisopropyl.

As used herein, the term “carrier” refers to a diluent, adjuvant, excipient, auxilliary agent or vehicle with which the active agents disclosed herein are delivered. Such “carriers” can be sterile liquids, such as water and oils, including those of petroleum oil such as mineral oil, and vegetable oils.

As used herein the term “carrier oil” refers to an oil base in which active components may be dissolved, dispersed or otherwise suspended and then subsequently delivered to the desired location. The carrier oil may be an oil in which other components of the pesticidal formulation have a high solubility.

Throughout this specification and the claims which follow, unless the context requires otherwise, the word “comprise”, or variations such as “comprises” and “comprising”, will be understood to imply the inclusion of a stated integer or step or group of integers or steps but not the exclusion of any other integer or step or group of integers or steps.

The term “concentration” as used herein, generally refers to the ordinary meaning of that term, namely the increase in the amount of a particular subject material per unit volume of the fluid in which the material is disposed, e.g., wholly or partially dissolved, suspended, slurried, etc.

The term “concentrate” as used herein, refers to a formulation that is generally diluted to form the use solution. The concentrate, for example, is often easier and less expensive to ship than the diluted solution due to comparative volumes.

The term “detergent” refers to substances that chemically interact with both oil and water, thus stabilising the interface between oil or water droplets in suspension.

The term “dilution”, as used herein, generally encompasses the ordinary meaning of that term, namely, the reduction in the amount of a particular subject material per unit volume of a fluid containing that material, through the addition of a second fluid, or diluent, to a first fluid which contains the subject material, e.g., soluble chemical component, or a suspension or emulsion of a partially insoluble material, whereby the resulting concentration of the subject material is reduced over that of the first fluid. In terms of the present invention, the diluent may take on a variety of forms, including aqueous or non-aqueous fluids and/or it may include additional material components, e.g., soluble chemical components or suspensions or emulsions of at least partially insoluble components.

As used herein the term “diluent” refers to a substance that is used to dilute another substance. Examples of diluents include, but are not limited to, water, alcohols (e.g. methanol, ethanol), ketones (e.g. acetone, methyl ethyl ketone), others (e.g. diethyl ether, dioxane, cellosolve, tetrahydrofuran), aromatic hydrocarbons (e.g. benzene, toluene, xylene, methyl naphthalene), aliphatic hydrocarbons (e.g. gasoline, kerosene, lamp oil), esters, nitrites, acid amides (e.g. dimethylformamide, dimethylacetamide), halogenated hydrocarbons (e.g. dichloroethane, chloroform), etc.

As used herein the term “dispersant” or variations such as “dispersing agent” refers to a material that increases the stability of a suspension of particles in a liquid medium by deflocculation of the primary particles.

As used herein the term “emulsifier” refers to a substance which stabilises an emulsion. Examples of emulsifiers are egg yolk (where the main emulsifying chemical is the phospholipid lecithin), and mustard, where a variety of chemicals in the mucilage surrounding the seed hull act as emulsifiers; proteins and low-molecular weight emulsifiers are common as well. In some cases, particles can stabilise emulsions as well through a mechanism called Pickering stabilisation.

As used herein, the term “emulsion” refers to a mixture of two immiscible (unblendable) substances. One substance (the dispersed phase) is dispersed in the other (the continuous phase). Emulsification is the process by which emulsions are prepared. Emulsions are part of a more general class of two-phase systems of matter called colloids. Although the terms colloid and emulsion are sometimes used interchangeably, emulsion tends to imply that both the dispersed and the continuous phase are liquid.

As used herein, the term “halo” as used alone or as part of a group such as “C₃₋₆halo alkenyl” refers to fluoro, chloro, bromo and iodo groups.

The term “optionally substituted” as used herein, unless otherwise indicated, means that a group may include one or more substituents that do not interfere with the binding activity of the compound of formula I. In some instances, the substituent may be selected to improve certain physico-chemical properties such as aqueous solubility under physiological conditions. Examples of optional substituents include halo, C₁₋₄alkyl, C₂₋₄alkenyl, C₂₋₄alkynyl, C₁₋₄alkoxy, haloC₁₋₄alkyl, hydroxyC₁₋₄alkyl, C₁₋₄alkoxy, C₁₋₄alkyl, hydroxy, aryl, amino, nitrile, mercapto, C₁₋₄alkylamino, C₁₋₄dialkylamino, aryloxy, formyl, C₁₋₄alkylcarbonyl and C₁₋₄alkoxycarbonyl.

As used herein, the term “pest” refers to an arachnid, helminth, mollusc, protozoa, insect, virus, bacteria, nematode, fungus, mould, weed, parasite or other form of unwanted living organism.

By “pesticidally effective amount” is meant the administration or application of an amount of formulation that contains at least one phenol and at least one isothiocyanate, which is effective for controlling pests including increasing the mortality or decreasing the growth of a significant number of pests, or that is noxious to, and/or induces behavioural changes in, a significant number of pests. The effective amount will vary depending upon the taxonomic group of pest exposed to the active compound, the formulation of the composition, and other relevant factors. It is expected that the amount will fall in a relatively broad range that can be determined through routine trials.

A used herein the term “pesticide” refers to any substance or mixture of substances intended for preventing, destroying, repelling, or mitigating any pest. Pests may be insects, mice and other animals, unwanted plants (weeds), fungi, or microorganisms like bacteria and viruses. The term pesticide also applies to herbicides, fungicides, and various other substances used to control pests. A pesticide is also any substance or mixture of substances intended for use as a plant regulator, defoliant, or desiccant.

As used herein, the term “phenol” and variations such as “phenolic” refers to an optionally substituted hydroxy benzene derivative. Examples of phenols include: 4-isopropylphenol, m-phenylphenol, carvacrol, thymol, 2-ethyl-5-isopropylphenol, 4-phenoxy-2-methylphenol, methyl salicylate, eugenol, zingerberone and the like.

As used herein the term “phytochemical” refers to any botanical chemical substance found in plants and plant-derived products. For example, phytochemicals may be chemicals that a plant produces to perform metabolic functions.

The term “plant extract” as used herein is intended to mean any substance which is derived, obtained or extracted from a plant or plant part by conventional separation techniques. In a preferred embodiment, the term “plant extract” as used herein is intended to mean any substance which is derived, obtained or extracted from a plant or plant part by conventional separation techniques and which has anti-bacterial activity. Typically, the term “plant extract” is intended to mean a substance selected from an essential oil, oleoresin or absolute. The term “oleoresin”, as used herein, is intended to mean the fraction obtained by solvent extraction from spices and herbs. The term “absolute”, as used herein, is intended to mean the fraction obtained by extrusion using alcoholic solvent. Absolutes are generally manufactured by alcoholic extrusion from an oleoresin. An essential oil is the volatile etherial fraction obtained from a plant or plant part by a physical separation method. The physical separation method usually involves either distillation (including water distillation, steam distillation, water and steam distillation and dry distillation) or expression (pressing). Enfleurage, a process in which a floral material is adsorbed onto fat and the essential oil obtained by alcoholic extraction from this fat, may also be used to obtain the essential oil. Generally, essential oils represent the odorous part of the plant material. The plant extracts are either available commercially or may be obtained from the plant or plant part by conventional separation techniques, as described above.

By “serial dilution” is generally meant successive dilutions, as defined herein, wherein the subject material is diluted with diluent to form a first diluted material, which first diluted material is then diluted with a diluent again, to produce a second diluted material, etc. For example, one produces a first diluted material that is diluted 1:10 over the subject material. By then diluting at least a portion of this material 1:10, one produces a second diluted material that is a 1:100 dilution of the subject material.

As defined herein, the term “spray colorant” refers to a dye that can be added, for example, to a spray tank so that an applicator is able to clearly identify which areas have already been treated.

As used herein, the term “spreader” or “film extender” (spreader-activator) refers to a substance that, when added, for example, to a pesticide formulation to be used in a spray mixture, increases the area that a given volume of spray will cover and improves the contact between the pesticidal formulation and the surface which is being sprayed, for example, plant, soil or contained spaces. Typically, a spreading agent builds spray deposits and improves weatherability.

As used herein, the term “sticker” refers to a material that, when added to a formulation to be used in a spray mixture, improves the adherence (tenacity) to surfaces, such as plant, soil or contained spaces, rather than increasing the initial deposit. Commercial sticking agents are oily in consistency and may increase the amount of, for example, suspended solids retained on plant surfaces by coating the particles with a resin or varnish-like film. Pesticides such as fungicides, may benefit from the use of stickers. Stickers may be judged in terms of resistance to wind and water, length of adherence, and mechanical or chemical action.

As used herein, the term “surfactant” refers to a chemical agent that lowers the surface tension of a liquid, allowing easier spreading, and provides a lower the interfacial tension between two liquids. The term surfactant is a contraction of “Surface active agent”. Surfactants are usually organic compounds that are amphipathic, meaning they contain both hydrophobic groups (their “tails”) and hydrophilic groups (their “heads”). Therefore, they are typically sparingly soluble in both organic solvents and water. Surfactants reduce the surface tension of water by adsorbing at the air-water interface. They also reduce the interfacial tension between oil and water by adsorbing at the liquid-liquid interface. Many surfactants can also assemble in the bulk solution into aggregates that are known as micelles. When micelles form in water, their tails form a core that is like an oil droplet, and their (ionic) heads form an outer shell that maintains favourable contact with water. When surfactants assemble in oil, the aggregate is referred to as a reverse micelle. In a reverse micelle, the heads are in the core and the tails maintain favourable contact with oil. Surfactants are particularly useful in accomplishing the wetting or penetration of solids by aqueous liquids and serve in the manner of detergent, emulsifying, or dispersing agents.

As used herein, the term “volume percent” refers to a percentage calculated by dividing the volume of a component of a mixture by the total volume of the mixture and multiplying this quotient by 100.

As used herein, the term “weight percent” refers to a percentage calculated by dividing the weight of a component of a mixture by the total weight of the mixture and multiplying this quotient by 100.

As used herein, a “wetting agent” refers to a compound that modifies the characteristics between phases, such as liquid-liquid phases, or solid-liquid phases, to promote contact between phase surfaces. As such a “wetting agent” is a material that increases the spreading of a liquid medium on a surface by reducing the surface tension of the liquid. A wetting agent may be a material which, when added to a pesticide, lowers the interfacial tension between a liquid and a solid; for example, a plant surface. Effectiveness is measured by the increase in spread of a liquid over a solid surface and the ability of the spray film to make complete contact with it. When a wetting agent reduces surface tension, spreading naturally occurs. Surfactants may be designed specifically for use with particular fungicides, insecticides, or herbicides.

In some embodiments, the carrier oil is selected from: a rape seed oil such as canola oil; sesame oil; sunflower oil; a polyunsaturated vegetable oil; neem oil; karanj oil; refined palm oil; sweet almond; apricot kernel; jojoba or grapeseed oil.

The compound(s) may be solubilised in a carrier by adding the compound(s) to the carrier and allowing the compound(s) to dissolve. In some instances, the application of stirring, agitation, or even heat may facilitate the dissolution of the compound(s) in the carrier.

The compounds employed in the methods of the present invention may be, for example, applied to the plants, plant parts, soil or contained spaces using conventional application techniques such as spraying.

Advantageously, the present pesticidal formulations, being relatively non-toxic, are highly advantageous in terms of their relative ease of application and toxicity profile to non-target organisms.

The pesticidal formulations of the present invention are effective agents for treating plants. Plants nearing or at maturity may be treated at any time before and during seed development. Fruit bearing plants may be treated before or after the onset of bud or fruit formation.

The pesticidal formulations of the present invention are effective agents for treating soil. The present pesticidal formulations may be largely comprised of naturally occurring organic substances, and may therefore be less harmful to the environment and less toxic to humans. The pesticidal formulations are typically biodegradable. The pesticidal formulations may be applied pre-planting and post-planting. The pesticidal formulations may be used as a broad spectrum treatments whereby different concentrations of the formulations can be applied to serve as a herbicidal, fungicidal, insecticidal, bactericidal or a nematicidal agents.

Suitably, the concentration of phenolic and isothiocyanate components of the pesticidal formulations described herein, are at a level that achieves optimal activity for all components when applied to soil, plants, timber or contained spaces such as shipping containers. In specific embodiments, the concentrations of the phenolic component and the isothiocyanate in the pesticidal formulations, are at a level where the antimicrobial and anti-pathogenic effects are additive and substantially complementary.

In specific embodiments, the concentrations of the components of the pesticidal formulation at a level where they have a synergistic action.

Suitably, the phenolic component of the pesticidal formulation is a compound of formula I:

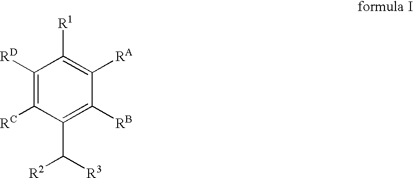

wherein:
R¹ is selected from hydrogen, hydroxide, C₁₋₆alkoxy or C₁₋₆alkyl, C₂₋₈alkenyl,
R^{A}, R^{B}, R^{C} and R^{D} are independently selected from hydrogen, hydroxy, C₁₋₄alkoxy or C₁₋₄alkyl provided that at least one of R^{A} to R^{D} is hydroxy; and
R² and R³ are independently selected from hydrogen, C₁₋₆alkyl, C₁₋₆alkanoyl, or C₂₋₈alkenyl.

In some embodiments, the pesticidal formulation includes a compound of formula I wherein: R¹, R² and R³ are methyl, R^{C} and R^{D} are hydrogen and R^{A} and R^{B} are independently selected from hydrogen or hydroxy.

The phenolic component of the pesticidal formulation, may be derived from natural sources or made synthetically.

In some embodiments, the one or more phenol of the pesticidal formulation is a component of one or more plant extracts.

An example of a natural phenolic extract is oregano oil. Oregano oil may be extracted from the leaves and flowers of the plant using a steam extraction process. The essential oil distilled from oregano typically includes thymol and carvacrol, both of which have antimicrobial and nematicidal activity.

As such, the one or more phenol may be a component of an oreganum sp. extract or oregano oil.

In specific embodiments, 65-85% weight percent of oregano oil is carvacrol but the amount may range between 20% and 100%.

Another non-limiting example of a natural phenolic extract is ajowan oil. Ajowan oil may be steam extracted, for example, from Carum copticum seeds. The main component of Ajowan oil is thymol. Ajowan oil has been shown to have some antiseptic and fungicide activity.

Suitably, the one or more phenol of the pesticidal formulation is a component of a carum copticum extract.

The inventors have surprisingly found that by using one or more phenolic compounds, particularly natural plant extracts high in phenolic compounds, in combination with one or more isothiocyanates, they were able to prepare a broad spectrum pesticide that is also a stable formulation. Without wishing to be bound by theory, the antioxidative as well as pesticidal properties of phenolic compounds combine with the pesticidal properties of isothiocyanates in a synergistic manner to provide stable pesticidal formulations with broad spectrum activity.

Suitably the phenolic compound of formula I is an anti-oxidant.

Further suitable phytochemical extracts containing phenolic compounds include: clove oil; basil oil; cinnamon oil; savory oil; parsley oil; thyme oil; boronia oil; bay oil; terpeneless bay oil; savory; cinnamon bark oil; pimenta berry oil; pimenta leaf oil; clove hull oil; clove stem oil; oak moss oil; oil of wintergreen and oil of birch.

In some embodiments, the isothiocyanate is a compound of formula II:

R⁴—N═C═S formula II

wherein:
R⁴ is selected from optionally substituted C₁₋₁₀alkyl, C₂₋₁₀alkenyl, aryl, and C₁₋₄alkylaryl.

In some embodiments, the pesticidal formulation contains 2-7% by weight of a phenol of formula I and 5-15% by weight of an isothiocyanate of formula II.

In other embodiments, the pesticidal formulation contains 4-5% by weight of a phenol of formula I and 8-12% by weight of an isothiocyanate of formula II.

Isothiocyanates can be derived from natural sources or made synthetically. In specific embodiments the isothiocyanate has a purity of greater than 90% by weight. Non-limiting examples of isothiocyanate compounds include: (a) allyl isothiocyanate (which may be synthetically obtained or alternatively naturally obtained from, for example, horseradish, mustard (particularly black mustard), turnip, cabbage, brussels sprout, kale, collards, and cauliflower), (b) 3-butenyl isothiocyanate (which may be synthetically obtained or alternatively naturally obtained from, for example, cabbage, horseradish, mustard, turnip, and rutabaga), (c) benzyl isothiocyanate (which may be synthetically obtained or alternatively naturally obtained from, for example, cress, radish, horseradish, and nasturtium), (d) 2-butyl isothiocyanate (which may be synthetically obtained or alternatively naturally obtained from, for example, horseradish, cabbage, brussels sprout, cauliflower, mustard, and spinach), (e) p-hydroxybenzyl isothiocyanate (which may be synthetically obtained or alternatively naturally obtained from, for example, mustard (particularly white mustard) and charlock), (f) methyl isothiocyanate (which may be synthetically obtained or alternatively naturally obtained from, for example, cabbage, cauliflower, brussels sprout, horseradish, and radish), (g) 4-methylthio-3-butenyl isothiocyanate (which may be synthetically obtained or alternatively naturally obtained from, for example, radish), (h) 4-pentenyl isothiocyanate (which may be synthetically obtained or alternatively naturally obtained from, for example, horseradish, mustard, turnip, rutabaga, cress, and radish), (i) 2-phenylethyl isothiocyanate (which may be synthetically obtained or alternatively naturally obtained from, for example, mustard, cabbage, horseradish, watercress, turnip, rapeseed), (j) phenyl isothiocyanate (which may be synthetically obtained or alternatively naturally obtained from, for example, mustard, spinach, and horseradish), (k) 6-methylsulfinylhexyl isothiocyanate (which may be synthetically obtained or alternatively naturally obtained from, for example, wasabi), (l) 3-methylsulfinylpropyl isothiocyanate (which may be synthetically obtained or alternatively naturally obtained from, for example, turnip), (m) isopropyl isothiocyanate (which may be synthetically obtained or alternatively naturally obtained from, for example, cabbage), (n) 3-methylthioalkyl isothiocyanate (which may be synthetically obtained or alternatively naturally obtained from, for example, cabbage), (o) 3-methylsulfonylpropyl isothiocyanate, (p) 2-hydroxy-3-butenyl isothiocyanate, (q) sec-but isothiocyanate (which may be synthetically obtained or alternatively naturally obtained from, for example, cress), (r) 4-methylthiobutyl isothiocyanate (which may be synthetically obtained or alternatively naturally obtained from, for example, rapeseed), (s) 4-methylpentyl isothiocyanate (which may be synthetically obtained or alternatively naturally obtained from, for example, rapeseed), (t) 2-hydroxy-4-pentenyl isothiocyanate (which may be synthetically obtained or alternatively naturally obtained from, for example, rapeseed), (u) 5-methylthiopentyl isothiocyanate (which may be synthetically obtained or alternatively naturally obtained from, for example, rapeseed), (v) 3-indolylmethyl isothiocyanate (which may be synthetically obtained or alternatively naturally obtained from, for example, rapeseed), (w) 4-hydroxy-3-indolylmethyl isothiocyanate (which may be synthetically obtained or alternatively naturally obtained from, for example, rapeseed), (x) 1-methoxy-3-indolylmethyl isothiocyanate (which may be synthetically obtained or alternatively naturally obtained from, for example, rapeseed), and (y) 4-methoxy-3-indolylmethyl isothiocyanate (which may be synthetically obtained or alternatively naturally obtained from, for example, rapeseed).

Non-limiting examples of other isothiocyanate compounds which may be utilised in the products and methods of the present invention include 1-adamantyl isothiocyanate; 1-naphthyl isothiocyanate; 2,4,6-trimethylphenylisothiocyanate; 2,4,6-trichlorophenyl isothiocyanate; 2,4-dichlorophenyl isothiocyanate; 2,4-dimethoxyphenyl isothiocyanate; 2,4-xylyl isothiocyanate; 2,5-dichlorophenyl isothiocyanate; 2,5-difluorophenyl isothiocyanate; 2,5-dimethoxyphenyl isothiocyanate; 2,6-difluorophenyl isothiocyanate; 2,6-dimethylphenyl isothiocyanate; 2-(methylthio) phenyl isothiocyanate; 2-(trifluoromethyl) phenyl isothiocyanate; 2-bromophenyl isothiocyanate; 2-chloro-4-nitrophenyl isothiocyanate; 2-chloro-5-(trifluoromethyl) phenyl isothiocyanate; 2-chloroethyl isothiocyanate; 2-chlorophenyl isothiocyanate; 2-ethylphenyl isothiocyanate; 2-fluorophenyl isothiocyanate; 2-iodophenyl isothiocyanate; 2-methoxy-4-nitrophenyl isothiocyanate; 2-methoxy-5-methylphenyl isothiocyanate; 2-methoxyphenyl isothiocyanate; 2-napthyl isothiocyanate; 2-phenethyl isothiocyanate; 2-phenylethyl isothiocyanate; phenethyl isothiocyanate; 3,3,5-trimethylcycohexyl isothiocyanate; 3,4,5-trimethoxyphenyl isothiocyanate; 3,4-dichlorophenyl isothiocyanate; 3,5-bis (trifluoromethyl) phenyl isothiocyanate; 3,5-di-tert-buryl-4-hydroxyphenyl isothiocyanate; 3,5-dichlorophenyl isothiocyanate; 3-(methylthio) propyl isothiocyanate; 3-(trifluoromethyl) phenyl-isothiocyanate; 3-bromophenyl isothiocyanate; 3-chlorophenyl isothiocyanate; 3-cyanophenyl isothiocyanate; 3-fluorophenyl isothiocyanate; 3-methoxyphenyl isothiocyanate; 3-methoxypropyl isothiocyanate; 3-nitrophenyl isothiocyanate; 3-pyridyl isothiocyanate; 4-(methylthio) phenyl isothiocyanate; 4-(trifluoromethyl) phenyl isothiocyanate; 4-bromo-2-chlorophenyl isothiocyanate; 4-bromophenyl isothiocyanate; 4-chlorophenyl isothiocyanate; 4-cyanophenyl isothiocyanate; 4-dimethylamino-1-naphthyl isothiocyanate; 4-ethylphenyl isothiocyanate; 4-fluorophenyl isothiocyanate; 4-iodophenyl isothiocyanate; 4-isopropylphenyl isothiocyanate; 4-methoxyphenyl isothiocyanate; 4-methyl-2-nitrophenyl isothiocyanate; 4-methylphenyl isothiocyanate; 4-nitrophenyl isothiocyanate; 5-chloro-2-methylphenyl isothiocyanate; m-tolyl isothiocyanate; o-tolyl isothiocyanate; p-tolyl isothiocyanate; tert-butyl isothiocyanate; acetyl isothiocyanate; benzoyl isothiocyanate; ethyl isothiocyanate; cyclohexyl isothiocyanate; hexyl isothiocyanate; methallyl isothiocyanate; methyl isothiocyanate; pentyl isothiocyanate; and 2,3-dichlorophenyl isothiocyanate.

In some embodiments the isothiocyanate is an alkyl, alkylaryl, or alkenyl isothiocyanate.

The isothiocyanate may be allyl isothiocyanate. Allyl isothiocyanate has antimicrobial including fungicidal activity.

Suitably, the pesticidal formulation may comprise an isothiocyanate precursor in the form of a glucosinolate of formula III:

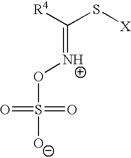

wherein R⁴ is a defined above; and
X is a sugar residue.

In some embodiments, the carrier oil is any suitable oil that can dissolve the other components of the pesticidal formulation and serve as a carrier.

In specific embodiments, the carrier is selected from a canola oil, sesame oil, sunflower oil, a polyunsaturated vegetable oil, neem oil, karanj oil and a refined palm oil.

Dissolving the other components of the pesticidal formulation in the carrier oil may extend the longevity of the activity by preventing or at least delaying volatilisation of the component oils and presenting the component oils to non-polar target sites. When the formulation is suitably diluted prior to application, the carrier oil supports the component oils in a plurality of oil droplets suspended in solution.

In some embodiments the pesticidal formulation further comprises a compound of formula IV;

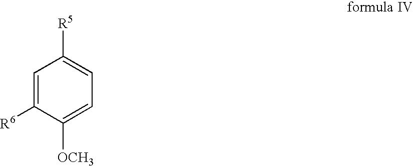

wherein:
R⁵ is selected from hydrogen, optionally substituted C₁₋₄alkyl, optionally substituted C₁₋₄alkenyl, optionally substituted C₁₋₄alkanoyl, carboxyl, or a C₁₋₄aldehyde; and
R⁵ is selected from hydrogen, optionally substituted C₁₋₄alkyl, optionally substituted C₁₋₄alkanoyl, carboxyl, or a C₁₋₄aldehyde;
provided that both R⁵ and R⁶ are not hydrogen.

Suitably, the compound of formula IV is a component of an aniseed, anise or star anise extract.

Aniseed anise (or Star Anise) oil has anisic, anethole, methyl chavicol and limonene. The main component is anethole. Aniseed anise (or Star Anise) oil has been shown to have antiseptic, bactericide and insecticide properties. Other suitable phytochemical extracts containing compounds of formula IV include tarragon oil (high in methyl chavicol) and fennel oil (high in anethole).

Exemplary compounds of formula IV include anis-ketone, anisaldehyde, methylanisole, estragol, ortho- and para-anisic acid, and cis- and trans-anethole.

In some embodiments the pesticidal formulation further comprises a curcumin or curcuminoid derivative.

Suitably, the curcuminoid is a compound of formula V or a tautomer or a mixture of tautomers thereof:

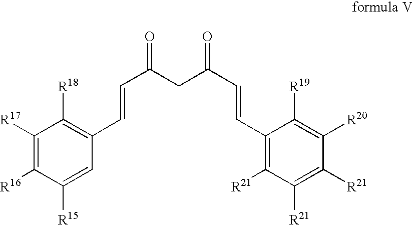

wherein;
R¹⁵ to R²¹ are independently selected from hydrogen, C₁₋₄alkoxy, and hydroxy.

Suitably, the curcuminoid is provided in the form of an extract of a plant of the ginger family Zingiberaceae, which plant may be of the genus Curcuma.

Suitably, the Curcuma species is Curcuma longa.

Curcumin has been shown to have a growth inhibitory effect for a variety of bacteria, parasites, and pathogenic fungi. An example of a naturally occurring substance high in curcumins and curcuminoids is turmeric oil.

Components of Curcuma longa extracts may include the following non-limiting substances: Bis-desmethoxycurcumin, bisabolene, borneol, isoborneol, cinnamic-acid, cuminyl-alcohol, curcumene, curcumenol, curcumin, curdione, curlone, curzerenone, curzerenone-c, cyclo-isoprenemyrcene, D-alpha-phellandrene, D-camphene, D-camphor, D-sabinene, dehydroturmerone, desmethoxycurcumin, tetrahydrocurcumin, tetrahydrodesmethoxycurcumin, dimethoxycurcumin, di-p-coumaroyl-methane, dicinnamoylmethane, didesmethoxycurcumin, tetrahydrodidesmethoxycurcumin, diferuloyl-methane, dihydrocurcumin, eugenol, feruloyl-p-coumaroyl-methane, gamma-atlantone, guaiacol, L-alpha-curcumene, L-beta-curcumene, limonene, monodesmethoxycurcumin, o-coumaric-acid, p-coumaric-acid, p-cymene, p-methoxycinnamic-acid, p-tolymethylcarbinol, Protocatechuic-acid, terpinene, terpineol, turmerone, ukonan-a, ukonan-b, ukonan-c, ukonan-d, vanillic-acid, zingiberone and zingiberene.

Suitably, the pesticidal formulation may further comprise one or more surfactants. When added to a pesticidal formulation, a surfactant may reduce the surface tension between two unlike materials, such as a spray film and a solid surface. For example, by adding a surfactant to a sprayer, oil and water will mix and can be sprayed on plant surfaces or the inner surfaces of a ship or rail container. With increasing emphasis on safe application of pesticides, such factors as droplet size, spray pattern, and pesticide drift have focused more attention on surfactants to give ideal coverage for pesticides.

Surfactants include: activators; compatibility agents; dispersants; detergents; stabilisers; emulsifiers; wetting agents; spreading agents; sticking agents; foam suppressants; or drift suppressants.

These materials may be, for example, added to a spray mixture to help keep pesticides in suspension; improve cohesiveness and dispersion of the spray; and increase the wetting (or coverage) of surfaces such as container walls, leaves, fruits, and stems.

The surfactant may be a non-ionic alkoxylate (typically ethoxylate) surfactant. Thus it may be an aliphatic alcohol alkoxylate, for example, an aliphatic alcohol ethoxylate. Further examples include: alcohol ethoxylates prepared from saturated or unsaturated, linear or branched aliphatic alcohols having on average from 8 to 20 carbon atoms, and which contain from 5 to 25, typically from 10 to 20, ethylene oxide units per molecule. Other suitable ethoxylates include the condensation products of ethylene oxide with fatty alcohols such as oleyl or cetyl alcohol, with alkyl phenols such as octyl- or nonylphenol, octylcresol or tristyryl phenol, with amines, with castor oil and with esters. Of particular interest are the sorbitan ester ethoxylates (e.g. Tween 20). Further suitable ethoxylates include the ethyleneoxide/propylene oxide/ethylene oxide block copolymers sold, for example, under the trade mark Pluronic.

Other examples of non-ionic surfactants include polyethylene glycol type surfactants such as: adducts of alkyl naphthols with ethylene oxide, polyoxyethylene (mono- or di-) (C₈-C₁₂alkyl) phenyl ethers, formalin condensates of polyoxyethylene ((mono- or di-) C₈-C₁₂alkyl) phenyl ethers, polyoxyethylene (mono-, di- or tri-) phenyl phenyl ethers, polyoxyethylene (mono-, di- or tri-) benzyl phenyl ethers, polyoxypropylene (mono-, di- or tri-) benzyl phenyl ethers, polyoxyethylene (mono-, di- or tri-) styryl phenyl ethers, polyoxypropylene (mono-, di- or tri-) styryl phenyl ethers, polyoxyethylene (mono-, di- or tri-) styryl phenyl ether polymers, polyoxyethylene polyoxypropylene block polymers, (C₁₂-C₁₈alkyl) polyoxyethylene polyoxypropylene block polymer ethers, (C₈-C₁₂alkyl) phenyl polyoxyethylene polyoxypropylene block polymer ethers, polyoxyethylene bisphenyl ethers, polyoxyethylene resin acid esters, polyoxyethylene (C₁₂-C₁₈fatty acid) monoesters, polyoxyethylene (C₁₂-C₁₈ fatty acid) esters, polyoxyethylene sorbitan (C₁₂-C₁₈ fatty acid) esters, adducts of glycerol fatty acid esters with ethylene oxide, adduct of castor oil with ethylene oxide, adduct of hardened castor oil with ethylene oxide, adducts of (C₁₂-C₁₈alkyl) amines with ethylene oxide, adducts of (C₁₂-C₁₈fatty acid) amides with ethylene oxide and the like.

Further examples of non-ionic surfactants include polyhydric alcohol type surfactants such as: glycerol fatty acid esters, polyglycerin fatty acid esters, pentaerythritol fatty acid esters, sorbitol (C₁₂-C₁₈ fatty acid) esters, sorbitan (C₁₂-C₁₈ fatty acid) esters, sucrose fatty acid esters, polyhydric alcohol alkyl ethers, fatty acid alkanol amides and the like.

Further examples of non-ionic surfactants include acetylene type surfactants such as: acetylene glycol, acetylene, alcohols, adduct of acetylene glycol with ethylene oxide, adducts of acetylene alcohols with ethylene oxide and the like.

Further examples of non-ionic surfactants include surfactants such as alkyl glycosides and the like

Examples of ionic surfactants include carboxylic acid type surfactants such as: carboxylic acids such as polyacrylic acid, polymethacrylic acid, polymaleic acid, copolymer of maleic acid and olefins (such as isobutylene and diisobutylene), copolymer of acrylic acid and itaconic acid, copolymer of methacrylic acid and itaconic acid, copolymer of maleic acid and styrene, copolymer of acrylic acid and methacrylic acid, copolymer of acrylic acid and methyl acrylate, copolymer of acrylic acid and vinyl acetate, copolymer of acrylic acid and maleic acid, N-methyl-(C₁₂-C₁₈ fatty acid) sarcosinates, resin acid and C₁₂-C₁₈ fatty acids, and salts thereof.

Further examples of ionic surfactants include sulfate type surfactants such as: sulfates such as (C₁₂-C₁₈alkyl) sulfates, polyoxyethylene (C₁₂-C₁₈alkyl) ether sulfates, polyoxyethylene (mono- or di-) C₈-C₁₂alkyl) phenyl ether sulfates, sulfates of polyoxyethylene ((mono- or di-) C₈-C₁₂alkyl) phenyl ether polymers, polyoxyethylene (mono-, di- or tri-) phenyl phenyl ether sulfates, polyoxyethylene (mono-, di- or tri-) benzyl phenyl ether sulfates, polyoxyethylene (mono-, di- or tri-) styryl phenyl ether sulfates, sulfates of polyoxyethylene (mono-, di- or tri-) styryl phenyl ether polymers, sulfates of polyoxyethylene polyoxypropylene block polymers, sulfonated oil, sulfated fatty acid esters, sulfated fatty acids and sulfated olefins, and salts thereof.

Further examples of ionic surfactants include sulfonic acid type surfactants such as: sulfonic acids such as (C₁₂-C₂₂ paraffin) sulfonic acids, (C₈-C₁₂alkyl) benzenesulfonic acids, formalin condensates of (C₈-C₁₂alkyl) benzenesulfonic acids, formalin condensate of cresolsulfonic acid, (a-olefin (C₁₄-C₁₆)) sulfonic acids, di (C₈-C₁₂alkyl) sulfosuccinic acids, lignin sulfonic acid, polyoxyethylene ((mono- or di-) C₈-C₁₂alkyl) phenyl ether sulfonic acids, polyoxyethylene (C₁₂-C₁₈alkyl) ether sulfosuccinic acid half esters, naphthalenesulfonic acid, ((mono- or di-) C₁-C₆alkyl) naphthalenesulfonic acids, formalin condensate of naphthalenesulfonic acid, formalin condensates of ((mono- or di-) C₁-C₆alkyl) naphthalenesulfonic acids, formalin condensate of creosote oil sulfonic acid, (C₈-C₁₂alkyl) diphenyl ether disulfonic acids, Igepon T (trade name), polystyrene sulfonic acid and copolymer of styrenesulfonic acid and methacrylic acid, and salts thereof.

Further examples of ionic surfactants include phosphate type surfactants such as: phosphates such as (C₈-C₁₂alkyl) phosphates, polyoxyethylene (C₁₂-C₁₈alkyl) ether phosphates, polyoxyethylene ((mono- or di-) C₈-C₁₂alkyl) phenyl ether phosphates, phosphates of polyoxyethylene ((mono-, di- or tri-) C₈-C₁₂alkyl) phenyl ether polymers, polyoxyethylene (mono-, di- or tri-) phenyl phenyl ether phosphates, polyoxyethylene (mono-, di- or tri-) benzyl phenyl ether phosphates, polyoxyethylene (mono-, di- or tri-) styryl phenyl ether phosphates, phosphates of polyoxyethylene (mono-, di- or tri-) styryl phenyl ether polymers, phosphates of polyoxyethylene polyoxypropylene block polymers, phosphatidyl choline, phosphatidyl ethanolimine and condensed phosphoric acid (such as tripolyphosphoric acid), and salts thereof.

The salts of ionic surfactants above include alkali metals (such as lithium, sodium and potassium), alkali earth metals (such as calcium and magnesium), ammonium and various amines (such as alkylamines, cycloalkylamines and alkanolamines).

Other examples of ionic surfactants include cationic surfactants, alkylamine salts, alkyl quaternary ammonium salts and the like, amphoteric surfactants such as: betain type surfactants, aminoacid type surfactants and the like, organosilicone surfactants, and organofluorine surfactants and the like.

The pesticidal formulation may comprise one or more emulsifiers. Whether an emulsion turns into a water-in-oil emulsion or an oil-in-water emulsion depends of the volume fraction of both phases and on the type of emulsifier. Generally, the Bancroft rule applies: emulsifiers and emulsifying particles tend to promote dispersion of the phase in which they do not dissolve very well; for example, proteins dissolve better in water than in oil and so tend to form oil-in-water emulsions (that is they promote the dispersion of oil droplets throughout a continuous phase of water). Suitably, the formulation is in the form of a cream.

Examples of emulsifies include alkylaryl sulphonates, ethoxylated alcohols, polyalkoxylated butyl ethers, calcium alkyl benzene sulphonates, polyalkylene glycol ethers and butyl polyalkylene oxide block copolymer. In some instances, natural organic emulsifiers may be preferred, particularly for organic farming applications. Coconut oils such as coconut diethanolamide is an example of such a compound. Palm oil products such as Lauryl stearate may also be used.

In some embodiments the pesticidal formulation may comprise one or more spreading or sticking agents. Spreaders and stickers can be used to help hold chemical formulations onto surfaces, for example leaf surfaces or container surfaces, for extended periods of time, and are usually used with insecticides and fungicides. For example, crop oil concentrates may act as penetrants, and also help, chemicals penetrate the waxy coatings of leaves, wherein a “crop oil concentrate” refers to products that contain 80 to 85% petroleum or vegetable oil plus 15 to 20% surfactant and emulsifiers. An emulsifiable oil generally refers to products that contain about 98% oil and 1 to 2% emulsifiers. This group is often called nonphytotoxic oils and phytobland oils.

Spreaders are typically organic alkanes, alkenes or polydimethylsiloxanes that provide a sheeting action of the treatment across the phylloplane. Suitable spreaders include paraffin oils and polyalkyleneoxide polydimethylsiloxanes. Commercial spreaders include TEGOPREN®, AGRIMAX®, DOW CORNING® 211, X-77®, SILWET® and the like. Penetrants such as sodium dodecylsulphate, formamides and lower aliphatic alcohols, may be used. Alkoxylation of an active component or otherwise chemically modifying the active components by incorporating a penetrant substance may be useful as formulation without additional surfactant can be achieved.

The present pesticidal formulation may also comprise a “dispersing agent” or “dispersant”. Examples of dispersants include: sodium 2-acrylamido-2-methylpropane sulphonate, or 2-acrylamido-2-methylpropane sulphonic acid, or acrylic acid/acrylic acid ester copolymer, or acrylic acid/2-acrylamido-2-methylpropane sulphonic acid copolymer or maleic anhydride/acrylic acid copolymer.

Drift of herbicide sprays may also be a problem when, for example, sensitive plants are in the vicinity of the site of application. One way to reduce herbicide drift is to increase the droplet size of the spray. Adjuvants (drift control agents) that are used to control drift do so in part by reducing the number of fine spray droplets. Thickeners may also be used as drift control agents.

Typically, when the pesticidal formulation is applied to soil as a pre-planting treatment, incubation is for 3 to 5 days. Length of the incubation period may depend on: the degree of dilution of the pesticidal formulation, the application method, and whether it is used as a herbicide, fungicide, nematicide or bactericide.

Typically, where the pesticidal formulation is used to eradicate or prevent weeds, dilutions of the pesticidal formulation of at least 2% by volume are used (that is: 2.0 parts pesticidal composition to 98.0 parts diluent).

In specific embodiments, when the pesticidal formulation is being used to treat soil, the method includes a further step of covering the soil after application to substantially prevent or slow the loss of the diluted pesticidal formulation from the treated soil. The treated soil may be covered with plastic. Where a covering is used, the soil may be incubated for 10 to 12 days before planting.

Application of the diluted pesticidal formulation may be performed with a spray unit to wet the soil surface and the wet soil turned over by a rotary hoe to achieve a 15 to 30 cm depth of exposure, drip pipes to saturate the soil and boom sprayer.

Typically, when the pesticidal formulation is used as a post-planting treatment, a high dilution of the pesticidal formulation, where there is substantially no herbicidal effects, may be used. In specific embodiments, the pesticidal formulation is diluted to a concentration between 0.5% and 1.0% by volume (that is: 0.5 to 1.0 part pesticidal composition to 99.0 to 99.5 parts diluent). The diluted pesticidal formulation may be applied by a boom sprayer where there is a crop.

The subsequent treatment(s) to a field of a growing crop may use a dilution of the pesticidal formulation suitable for a particular job. For example, if it is desired to eradicate weeds then an at least 2% by volume dilution may be used (that is: 2.0 parts pesticidal composition to 98.0 parts diluent), if is an antimicrobial effect is desired, then an at least 0.5% to 1.0% by volume dilution may be used (that is: 0.5 to 1.0 part pesticidal composition to 99.0 to 99.5 parts diluent).

The invention will now be described with reference to the following examples that illustrate some preferred aspects of the present invention. However, it is to be understood that the particularity of the following description of the invention is not to supersede the generality of the preceding description of the invention

### EXAMPLES

### Example 1.0

### Pesticidal Formulations

In the following examples formulations and dilutions of pesticidal formulations are expressed as volume percentages.

### Example 1.1

### Preparation of Pesticidal Formulation (A)

To a flask (5 L) is allyl isothiocyanate (AITC) (1 L) and ajowan oil (1 L). The mixture is stirred until homogeneity to provide pesticidal concentrate (A). The pesticidal concentrate (A) is then transferred to an air-tight container and shelved at room temperature.

### Example 1.1

### Preparation of Pesticidal Formulation (A1)

To a flask (20 L) is added allyl isothiocyanate (AITC) (1 L), ajowan oil (1 L) and emulsifiable canola oil (8 L). The mixture is then stirred until homogeneity to provide pesticidal concentrate (A). The pesticidal concentrate (A) is then transferred to an air-tight container and shelved at room temperature.

### Example 1.1

### Preparation of Pesticidal Formulation (B)

To a flask (10 L) is added oregano oil (1 L), tumeric oil (1 L), allyl isothiocyanate (AITC) (2 L), ajowan oil (1 L) and anise oil (1 L). The mixture is then stirred until homogeneity to provide pesticidal concentrate (B). The pesticidal concentrate (B) is then transferred to an air-tight container and shelved at room temperature.

### Example 1.1

### Preparation of Pesticidal Formulation (B1)

To a flask (40 L) is added emulsifiable canola oil (14 L), oregano oil (1 L), tumeric oil (1 L), allyl isothiocyanate (AITC) (2 L), ajowan oil (1 L) and anise oil (1 L). The mixture is then stirred until homogeneity to provide pesticidal formulation (B1). The pesticidal formulation (B1) is then transferred to an air-tight container and shelved at room temperature.

TABLE 1
Examples of Pesticidal formulations

| | Ingredient (Volume Percent) | | | | | | | | | | | | | | | |
|---|---|---|---|---|---|---|---|---|---|---|---|---|---|---|---|---|
| | | Isothio- | | | | | | | | | | | | | | |
| | | cyanates | | | Phenols | | | | | | | | | Curcuminoid | Anethole | |
| No. # | Carrier | A | B | C | P-1 | P-2 | P-3 | P-4 | P-5 | P-6 | P-7 | P-8 | P-9 | Cur-1 | Ans-1 | TOTAL |
| 1 | | 95 | | | 5 | | | | | | | | | | | 100 |
| 2 | | 90 | | | 10 | | | | | | | | | | | 100 |
| 3 | | 85 | | | 15 | | | | | | | | | | | 100 |
| 4 | | 80 | | | 20 | | | | | | | | | | | 100 |
| 5 | | 75 | | | 25 | | | | | | | | | | | 100 |
| 6 | | 70 | | | 30 | | | | | | | | | | | 100 |
| 7 | | 65 | | | 35 | | | | | | | | | | | 100 |
| 8 | | 60 | | | 40 | | | | | | | | | | | 100 |
| 9 | | 55 | | | 45 | | | | | | | | | | | 100 |
| 10 | | 50 | | | 50 | | | | | | | | | | | 100 |
| 11 | | 45 | | | 55 | | | | | | | | | | | 100 |
| 12 | | 40 | | | 60 | | | | | | | | | | | 100 |
| 13 | | 35 | | | 65 | | | | | | | | | | | 100 |
| 14 | | 30 | | | 70 | | | | | | | | | | | 100 |
| 15 | | 25 | | | 75 | | | | | | | | | | | 100 |
| 16 | | 20 | | | 80 | | | | | | | | | | | 100 |
| 17 | | 15 | | | 85 | | | | | | | | | | | 100 |
| 18 | | 10 | | | 90 | | | | | | | | | | | 100 |
| 19 | | 5 | | | 95 | | | | | | | | | | | 100 |
| 20 | | 95 | | | 1.25 | 1.25 | | | | | | | | 1.25 | 1.25 | 100 |
| 21 | | 90 | | | 2.5 | 2.5 | | | | | | | | 2.5 | 2.5 | 100 |
| 22 | | 85 | | | 3.75 | 3.75 | | | | | | | | 3.75 | 3.75 | 100 |
| 23 | | 80 | | | 5 | 5 | | | | | | | | 5 | 5 | 100 |
| 24 | | 75 | | | 6.25 | 6.25 | | | | | | | | 6.25 | 6.25 | 100 |
| 25 | | 70 | | | 7.5 | 7.5 | | | | | | | | 7.5 | 7.5 | 100 |
| 26 | | 65 | | | 8.75 | 8.75 | | | | | | | | 8.75 | 8.75 | 100 |
| 27 | | 60 | | | 10 | 10 | | | | | | | | 10 | 10 | 100 |
| 28 | | 55 | | | 11.25 | 11.25 | | | | | | | | 11.25 | 11.25 | 100 |
| 29 | | 50 | | | 12.5 | 12.5 | | | | | | | | 12.5 | 12.5 | 100 |
| 30 | | 45 | | | 13.75 | 13.75 | | | | | | | | 13.75 | 13.75 | 100 |
| 31 | | 40 | | | 15 | 15 | | | | | | | | 15 | 15 | 100 |
| 32 | | 35 | | | 16.25 | 16.25 | | | | | | | | 16.25 | 16.25 | 100 |
| 33 | | 30 | | | 17.5 | 17.5 | | | | | | | | 17.5 | 17.5 | 100 |
| 34 | | 25 | | | 18.75 | 18.75 | | | | | | | | 18.75 | 18.75 | 100 |
| 35 | | 20 | | | 20 | 20 | | | | | | | | 20 | 20 | 100 |
| 36 | | 15 | | | 21.25 | 21.25 | | | | | | | | 21.25 | 21.25 | 100 |
| 37 | | 10 | | | 22.5 | 22.5 | | | | | | | | 22.5 | 22.5 | 100 |
| 38 | | 5 | | | 23.75 | 23.75 | | | | | | | | 23.75 | 23.75 | 100 |
| 39 | | 10 | | | | 15 | 24 | | | | | 11 | | 30 | 10 | 100 |
| 40 | | 20 | | | 40 | | | 5 | 15 | | 20 | | | | | 100 |
| 41 | | 15 | | | 5 | 5 | | | 5 | 15 | 15 | | 15 | 10 | 15 | 100 |
| 42 | | | 20 | | 15 | 5 | | 10 | | 15 | | 30 | | 5 | | 100 |
| 43 | 30 | | | 10 | 5 | 5 | | 5 | 5 | 5 | 5 | 5 | 10 | 5 | 10 | 100 |
| 44 | | | 50 | | | | | | 17 | | | 3 | 11 | 7 | 12 | 100 |
| 45 | 20 | | | 10 | 20 | | | | 10 | | | | 20 | 10 | 10 | 100 |
| 46 | | | | 50 | 15 | 15 | | | | | | 5 | | 10 | 5 | 100 |
| 47 | | | 45 | | | 10 | | 10 | 15 | | | | 4 | 8 | 8 | 100 |
| 48 | | | | 30 | 15 | | 18 | | 2 | | 5 | | | 20 | 10 | 100 |
| 49 | | | 30 | | | | 14 | | | 50 | | | | 1 | 5 | 100 |
| 50 | | | | 45 | 10 | | | 5 | | 5 | | 5 | 10 | 10 | 10 | 100 |
| 51 | | | 45 | | 10 | | | 5 | | 5 | | 5 | 10 | 10 | 10 | 100 |
| 52 | 70 | | | 20 | | | 10 | | | | | | | | | 100 |
| 53 | 70 | 20 | | | | | | 10 | | | | | | | | 100 |
| 54 | 70 | | | 20 | | | | 5 | | 2.5 | | | | | 2.5 | 100 |
| 55 | 70 | | 20 | | 2.5 | | 2.5 | | | | | | | 2.5 | 2.5 | 100 |
| 56 | 70 | 10 | | | | 5 | | | | 5 | | | | 5 | 5 | 100 |
| 57 | 70 | | | 10 | | | | 10 | | | 5 | | | 2.5 | 2.5 | 100 |
| 58 | 60 | | 10 | | | | | | | | 10 | 10 | | 5 | 5 | 100 |
| 59 | 60 | | | 20 | | 5 | | | 5 | | | | 10 | 2.5 | 2.5 | 105 |
| 60 | 60 | | | 10 | | | 5 | | | 15 | 10 | | | 5 | 5 | 110 |
| 61 | 60 | | 10 | | | | 5 | | | 5 | | 15 | | 2.5 | 2.5 | 100 |
| 62 | 70 | 10 | | | 5 | 5 | | | | | | | | 5 | 5 | 100 |
| 63 | 70 | 10 | | | 5 | | 5 | | | | | | | 5 | 5 | 100 |
| 64 | 70 | 10 | | | 5 | | | 5 | | | | | | 5 | 5 | 100 |
| 65 | 70 | 10 | | | 5 | | | | 5 | | | | | 5 | 5 | 100 |
| 66 | 70 | 10 | | | 5 | | | | | 5 | | | | 5 | 5 | 100 |
| 67 | 70 | 10 | | | 5 | | | | | | 5 | | | 5 | 5 | 100 |
| 68 | 70 | 10 | | | 5 | | | | | | | 5 | | 5 | 5 | 100 |
| 69 | 70 | 10 | | | 5 | | | | | | | | 5 | 5 | 5 | 100 |
| 70 | 70 | 10 | | | | 5 | 5 | | | | | | | 5 | 5 | 100 |
| 71 | 70 | 10 | | | | 5 | | 5 | | | | | | 5 | 5 | 100 |
| 72 | 70 | 10 | | | | 5 | | | 5 | | | | | 5 | 5 | 100 |
| 73 | 70 | 10 | | | | 5 | | | | 5 | | | | 5 | 5 | 100 |
| 74 | 70 | 10 | | | | 5 | | | | | 5 | | | 5 | 5 | 100 |
| 75 | 70 | 10 | | | | 5 | | | | | | 5 | | 5 | 5 | 100 |
| 76 | 70 | 10 | | | | 5 | | | | | | | 5 | 5 | 5 | 100 |
| 77 | 70 | 10 | | | | | 5 | 5 | | | | | | 5 | 5 | 100 |
| 78 | 70 | 10 | | | | | 5 | | 5 | | | | | 5 | 5 | 100 |
| 79 | 70 | 10 | | | | | 5 | | | 5 | | | | 5 | 5 | 100 |
| 80 | 70 | 10 | | | | | 5 | | | | 5 | | | 5 | 5 | 100 |
| 81 | 70 | 10 | | | | | 5 | | | | | 5 | | 5 | 5 | 100 |
| 82 | 70 | 10 | | | | | 5 | | | | | | 5 | 5 | 5 | 100 |
| 83 | 70 | 10 | | | | | | 5 | 5 | | | | | 5 | 5 | 100 |
| 84 | 70 | 10 | | | | | | 5 | | 5 | | | | 5 | 5 | 100 |
| 85 | 70 | 10 | | | | | | 5 | | | 5 | | | 5 | 5 | 100 |
| 86 | 70 | 10 | | | | | | 5 | | | | 5 | | 5 | 5 | 100 |
| 87 | 70 | 10 | | | | | | 5 | | | | | 5 | 5 | 5 | 100 |
| 88 | 70 | 10 | | | | | | | 5 | 5 | | | | 5 | 5 | 100 |
| 89 | 70 | 10 | | | | | | | 5 | | 5 | | | 5 | 5 | 100 |
| 90 | 70 | 10 | | | | | | | 5 | | | 5 | | 5 | 5 | 100 |
| 91 | 70 | 10 | | | | | | | 5 | | | | 5 | 5 | 5 | 100 |
| 92 | 70 | 10 | | | | | | | | 5 | 5 | | | 5 | 5 | 100 |
| 93 | 70 | 10 | | | | | | | | 5 | | 5 | | 5 | 5 | 100 |
| 94 | 70 | 10 | | | | | | | | 5 | | | 5 | 5 | 5 | 100 |
| 95 | 70 | 10 | | | | | | | | | 5 | 5 | | 5 | 5 | 100 |
| 96 | 70 | 10 | | | | | | | | | 5 | | 5 | 5 | 5 | 100 |
| 97 | 70 | 10 | | | | | | | | | | 5 | 5 | 5 | 5 | 100 |
| 98 | 70 | 10 | | | 10 | | | | | | | | | 5 | 5 | 100 |
| 99 | 70 | 10 | | | | 10 | | | | | | | | 5 | 5 | 100 |
| 100 | 70 | 10 | | | | | 10 | | | | | | | 5 | 5 | 100 |
| 101 | 70 | 10 | | | | | | 10 | | | | | | 5 | 5 | 100 |
| 102 | 70 | 10 | | | | | | | 10 | | | | | 5 | 5 | 100 |
| 103 | 70 | 10 | | | | | | | | 10 | | | | 5 | 5 | 100 |
| 104 | 70 | 10 | | | | | | | | | 10 | | | 5 | 5 | 100 |
| 105 | 70 | 10 | | | | | | | | | | 10 | | 5 | 5 | 100 |

### Key to Table 1

### Carrier:

A: Allyl isothiocyanate
B: 3-Butenyl isothiocyanate
C: Benzyl isothiocyanate

### P-1: Oregano Oil

### P-2: Ajowan Oil

### P-3: Clove Oil

### P-4: Basil Oil

### P-5: Cinnamon Oil

### P-6: Savory Oil

### P-7: Parsley Oil

### P-8: Thyme Oil

### P-9: Terpeneless bay oil

### Cur-1: Tumeric Oil

### Ans-1: Anise Oil

### Example 1.2

### Preparation of Varying Dilutions of Pesticidal Formulation

Varying dilutions of pesticidal formulation (A1-1-A1-7 and B1-1-B1-6) were prepared. The diluted formulations were prepared by aqueous dilution. The resulting formulations were agitated to induce emulsification. The amount of formulation administered per kg of soil for each of the dilutions is displayed in Table 2. As appropriate, metham sodium was used as a comparative agent. The amount of metham sodium (42.3% methyl isothiocyanate) applied per kg of soil is also displayed in Table 2.

TABLE 2
Treatments and rates applied to determine the efficacy of pesticidal
formulations for the control of root-knot nematode

| | Product applied | |
|---|---|---|
| Treatment | per kg soil | |
| Untreated | 0 | |
| Metham sodium | 25 | μL |
| 0.2% PESTICIDAL FORMULATION (A1-1) | 2.0 | mL |
| 0.1% PESTICIDAL FORMULATION (A1-2) | 1.0 | mL |
| 0.05% PESTICIDAL FORMULATION (A1-3) | 0.5 | mL |
| 0.02% PESTICIDAL FORMULATION (A1-4) | 0.2 | mL |
| 0.002% PESTICIDAL FORMULATION (A1-5) | 20 | μL |
| 0.0002% PESTICIDAL FORMULATION (A1-6) | 2.0 | μL |
| 2.0% PESTICIDAL FORMULATION (A1-7) | 20 | mL |
| 0.02% PESTICIDAL FORMULATION (B1-1) | 0.2 | mL |
| 1.0% PESTICIDAL FORMULATION (B1-2) | 10 | mL |
| 2.0% PESTICIDAL FORMULATION (B1-3) | 20 | mL |
| 3.0% PESTICIDAL FORMULATION (B1-4) | 30 | mL |
| 5.0% PESTICIDAL FORMULATION (B1-5) | 50 | mL |
| 0.13% PESTICIDAL FORMULATION (B1-6) | 1.3 | mL |

### Example 2.0

### Efficacy to Control Root-Knot Nematode—Pot Trial

The efficacy of pesticidal formulations in the control of root-knot nematode (Meloidogyne javanica) as a pre-plant soil pesticidal formulation was investigated.

### Example 2.1

### Method

The root-knot nematode colonies were prepared with 1 kg of river sand placed in 100 mm diameter pots. The sand was inoculated with 10,000 eggs of root-knot nematode (M. javanica). The eggs were harvested from the roots of infected tomato plants (Lycopersicon esculentum cv. Tiny Tim) by washing in a 1% bleach solution for 3 minutes, collecting the roots on a 25 μm sieve and rinsing in running tap water for 2 minutes.

The appropriate treatment was applied to each pot in 5 mL of water using five 1 mL injections spaced evenly around the pot. Each dilution of the pesticidal formulation was applied using a pipette so that the tip of the pipette was 20 mm below the soil surface. The pots were allowed to stand for 7 days before planting a three week old tomato plant (c.v. Tiny Tim) in each pot.

Six weeks after planting the tomatoes were harvested. The tops of the plants were removed and dried for 4 days at 70° C. before being weighed. The roots were rated for the amount of galling (0=no galls, 10=dead roots) and then cut into 20 mm pieces, placed in a misting chamber for 7 days to extract the juvenile nematodes from the roots. The juvenile nematodes were collected on a 25 μm sieve, backwashed and counted using a compound microscope at 40× magnification.

### Example 2.2

### Results and Discussion

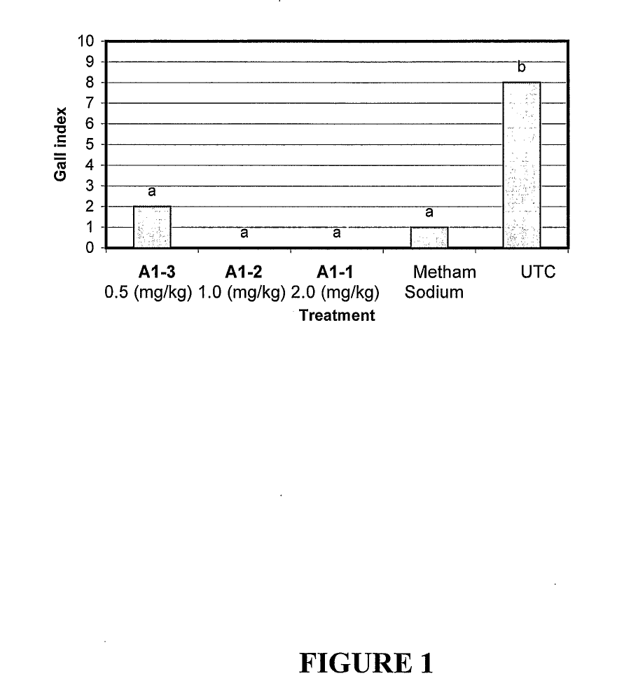

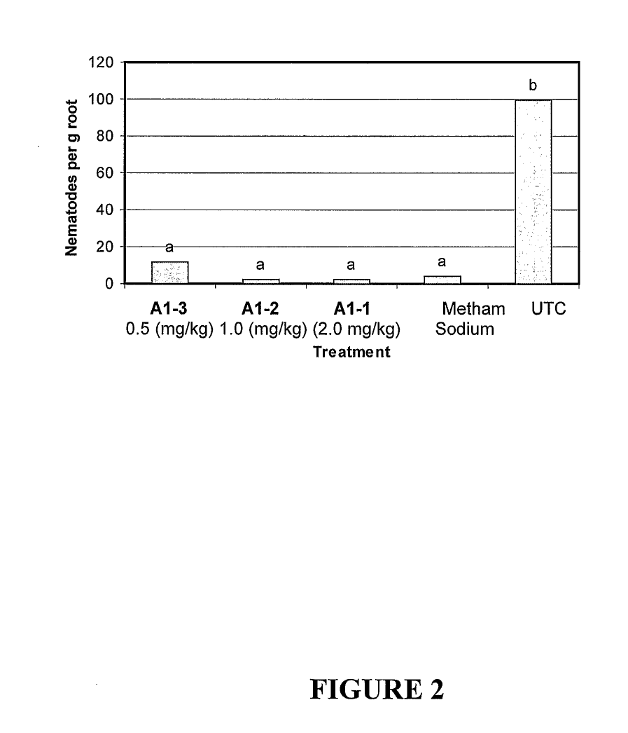

There were significantly fewer galls and juvenile root-knot nematodes on the root system of tomato plants treated with all three rates of the pesticidal formulation (A1-1, A1-2, and A1-3) and metham sodium relative to the untreated control (FIGS. 1 and 2). The use of pesticidal formulation at the lowest rate, 0.5 mL (A1-3) of product per kg of soil, was equally as effective at controlling root-knot nematode as metham sodium. No galls were detected on the roots of plants treated with the two highest rates of pesticidal formulation, 1.0 and 2.0 ml per kg of soil (A1-1 and A1-2 respectively) (FIG. 1) and very low numbers of juvenile were extracted from the roots (FIG. 2).

### Example 2.3

### Determination of LD50

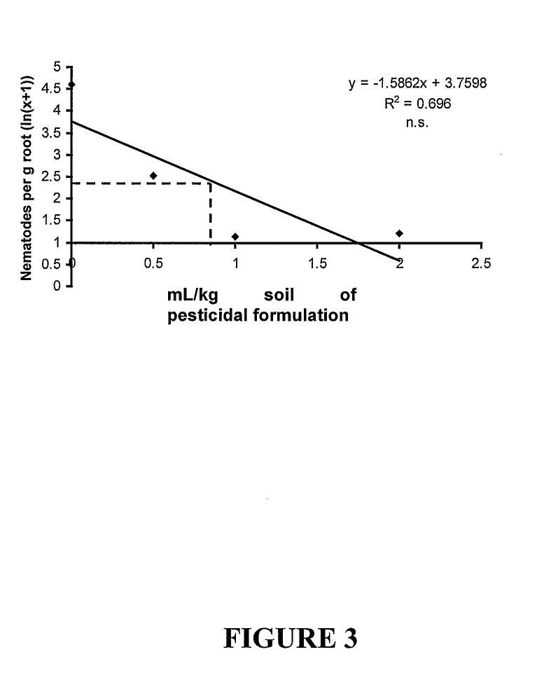

Determination of the LD 50 (lethal dose to kill 50% of the population) was calculated to be 0.87 ml of pesticidal formulation (A1) per kg of soil (FIG. 3). The LD50 was calculated from FIG. 3, by determining the half way point (2.38) between the maximum x value (3.76) and 1. Since a ln value of 1 is equal to 0 nematodes, this is the minimum number of nematodes that can be found in the roots of plants (FIG. 3). The LD50 was then calculated from the equation on FIG. 3 to produce a LD50 value of 0.87 mL per kg soil. This suggested that an application rate of 0.87 mL of pesticidal formulation per kg of soil is the most efficient rate of application to control nematodes without excessive use of the chemical.

The application of pesticidal formulation (A1) from between 0.5 to 1.0 mL per kg of soil before planting was the most efficient rate to reduce root-knot nematode numbers in soil. Control of root-knot nematode using pesticidal formulation was equally as effective as metham sodium and significantly better than the untreated control.

### Example 3

### Laboratory Trials of Fumigation for Controlling Bacterial Wilt

In the laboratory, pesticidal formulation (A1) was added at different rates to soil containing bacterial wilt. On a sandy soil, 1 mL of different pesticidal formulation dilutions (0.2% (A1-1), 0.02% (A1-4), 0.002% (A1-5) and 0.0002% (A1-6)) were added to 10 g infested soil. Canola oil and water controls were used. The pesticidal formulation at 0.2% (A1-1) reduced the population from 21 million CFU to 0.6 million CFU per gram of soil.

### Example 4

### Field Trial with Tomatoes and Asian Vegetables

Replicate trial of two soil beds for each of beans, tomatoes and Asian vegetables were saturated with 0.2% pesticidal formulation (A1-1) solution before planting. Pesticidal formulation (A1-1) treated soil beds were selected such that the trial beds were six beds apart. One week after spraying, vegetables were planted on pesticidal formulation (A1-1) treated soil beds after a week. There was no sign of root knot nematodes in pesticidal formulation (A1-1) treated soils. The presence of root knot nematodes was detected in the untreated beds. The worst affected plant was tomato in the untreated beds. No nematodes were present in treated beds. In conclusion, the application of 0.2% pesticidal formulation (A1-1) solution completely controlled root knot nematodes in beans, tomatoes and Asian vegetables.

### Example 5

### Field Trial with Broccoli

2×100 kg samples of known club root diseased soil were collected from the field and placed into two pots made of 200 kg plastic drum cut in half. One pot was treated with 2% pesticidal formulation (A1-7) by pouring the solution evenly over the soil. Both pots received moisture and normal fertiliser for broccoli. Three week disease-free broccoli seedlings were planted in each pot and the pots were watered for plant growth. The plants in untreated pots developed longer stems and flowered earlier with less leaf development than the treated pot. Club root damage was inspected by uprooting the plants. There was well developed healthy root system with myriads of hairline roots and no sign of club root damage in the plants planted in the pesticidal formulation (A1-7) treated pot. The plants in the untreated pot showed enlarged root cells that appeared thick, distorted, spindle-shaped, knobby, spherical, or club-shaped. There was no developed root system due to immense club root activity.

Club root is caused by Plasmodiophora brassicae and it causes severe crop losses in many areas of the world where vegetables such as broccoli, cauliflower, domestic cabbage, Brussels sprouts and Chinese cabbage are grown.

The lifecycle of P. brassicae is complex and not well understood. Resting spores in the soil germinate and infect the root hairs. Infected root hairs contain plasmodia that differentiate to yield secondary zoospores. These secondary zoospores subsequently reinfect the roots and enter the cortex. This results in swollen, galled roots.

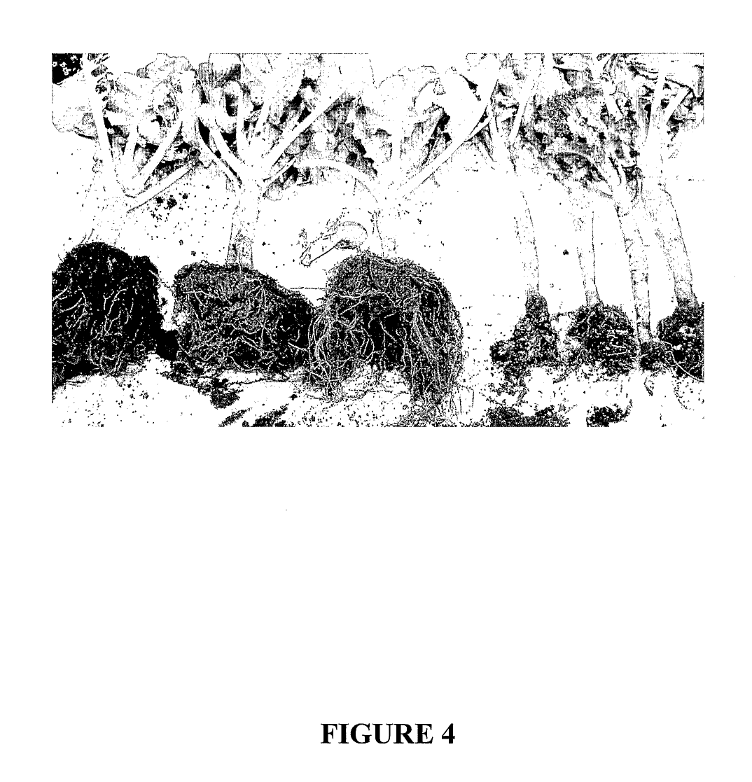

Plants that are infected within 3-4 weeks of transplanting develop severe galling of the taproot and generally have few if any healthy roots. Crop losses are severe. Plants infected later in the growing season develop galls on the lateral roots. These impair crop growth and yield, but complete crop loss is rare. Protection of the roots of the young transplant from infection in the first 3-4 weeks after planting is therefore necessary. With the use of 2% pesticidal formulation (A1-7) solution, the treatment substantially prevented subsequent root hair and cortical stages of infection by P. brassicae. FIG. 4 shows the results of samples of the developed root systems in plants treated with pesticidal formulation (A1-7) and untreated. The trials demonstrated that pesticidal formulation (A1-7) is an effective soil drench to control club root of Bressicas.

### Example 6

### Field Trial with Flowers

The application of 2% pesticidal formulation (B1-3) solution to the propagation of flowers was trialed and examined.

Pesticidal formulation (B1-3) as pre-plant soil treatment to propagate carnation cuttings was trialed. The cuttings thrived in the pesticidal formulation (B1-3) treated growing media (pumice) and produced healthy rooted cuttings. Pesticidal formulation (B1-3) was diluted at the rate of 1:100 (providing pesticidal formulation B1-1) and applied to the pumice beds by hand held garden can sprayer to saturate the pumice media. The carnation cuttings were planted 4-5 days after pesticidal formulation treatment and achieved a relatively high strike rate

### Example 7

### Field Trial with Flowers

A 1% (B1-2), 3% (B1-4), and 5% (B1-5) pesticidal formulation solution were trialed as pre-plant soil pesticidal formulation before planting flower bulbs. Methyl bromide served as a control. The aim was to determine the effectiveness of pesticidal formulation (B1) as a herbicide.

The 1% pesticidal formulation (B1-2) solution trial gave similar result to methyl bromide, while 3% (B1-4) and 5% (B1-5) pesticidal formulation solution trials showed no sign of weeds.

### Example 8

### Trial Comparing Different Pretreatments in Controlling Club Root Infection

3 kg of Club root infested soil were put in each pot and following treatments administered (Left to right):

| | |
|---|---|
| 1^{st}. Row: | Control |
| 2^{nd}. Row: | 250 ml of 0.13% pesticidal formulation (B1-6) solution. |
| 3^{rd}. Row: | Rape cake 50 gm + 50 mL alcohol + 250 mL water. |
| 4^{th}. Row: | Chinese Kale leaf 250 gm + 50 mL alcohol + 250 mL water. |
| 5^{th}. Row: | Lime 50 gm. |
| 6^{th}. Row: | Mustard leaf 250 gm + 50 mL alcohol + 250 mL water. |
| 7^{th}. Row: | 70% alcohol 50 mL. |

Ten days after treatment, Chinese cabbage seeds were sown. Growth was observed. After 45 days the plants were irrigated to loosen the soil and gently uprooted to wash the roots to observe symptoms of club root (Plasmodiophora brassicae) and soft root (Erwinia sp).

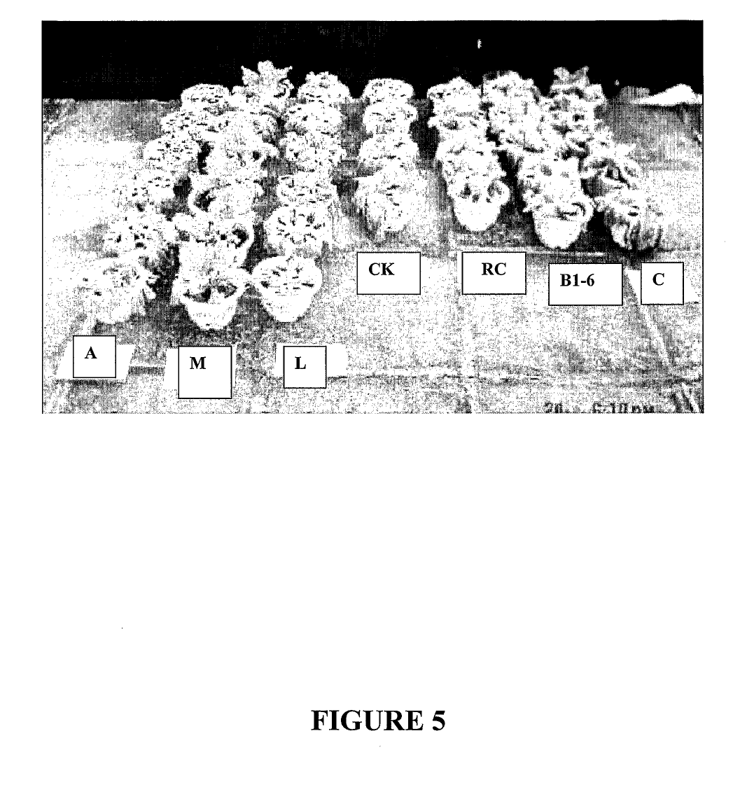

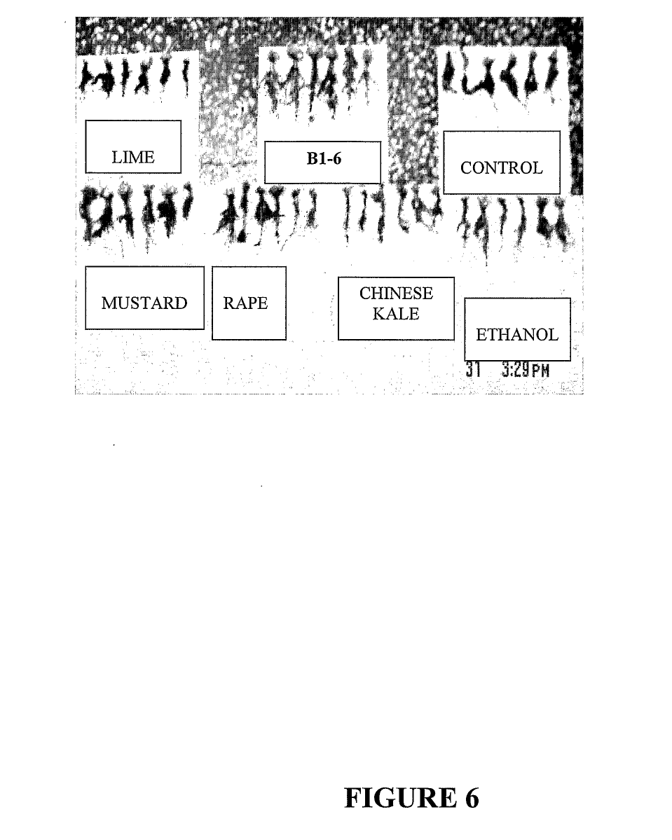

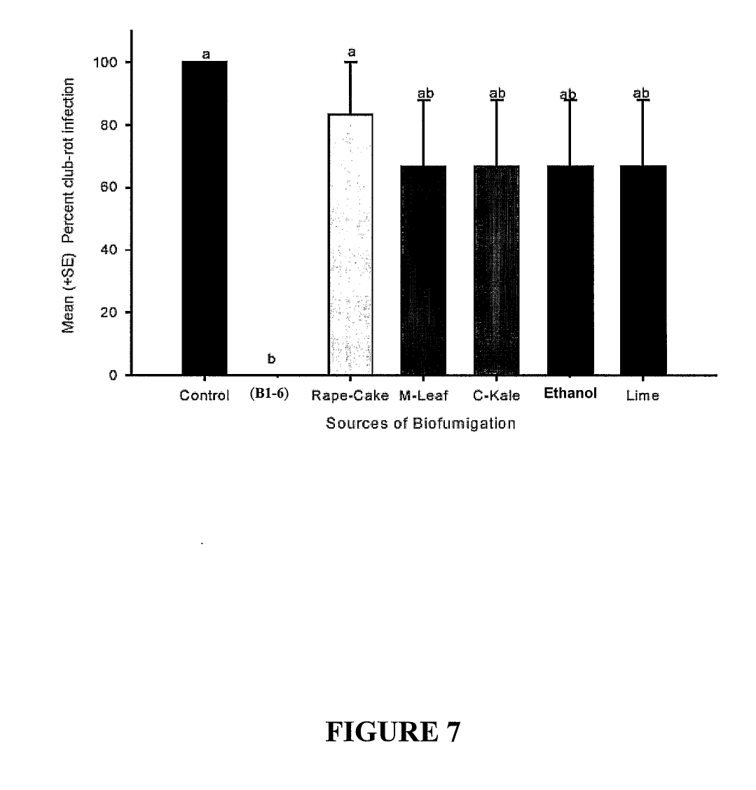

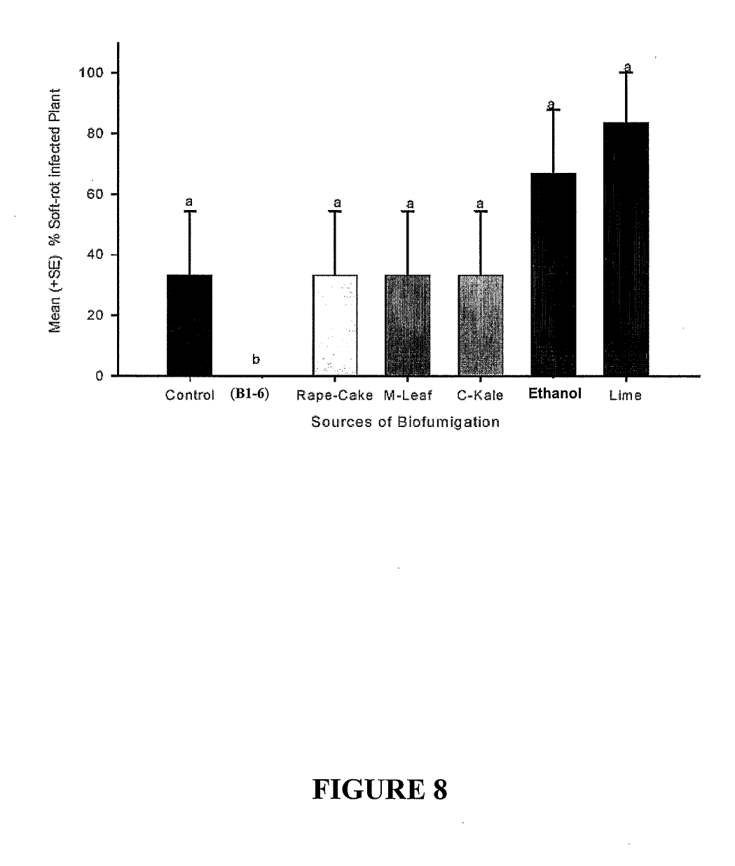

Pesticidal formulation (B1-6) treated pots showed no symptoms of Club root or Soft Root bacteria while other treatments had 67% to 100% Club root symptoms and 33% to 83% symptoms of Soft Root bacteria. Growth of the plants is shown in FIG. 5. FIG. 6 shows the increased length of roots of Chinese cabbage plants pre-treated with pesticidal formulation (B1-6) compared with the other types of treatments. The results were compiled and graphical shown. Compared with other pre-treatments, the use of pesticidal formulation (B1-6) controlled club root infection (FIG. 7) and soft rot infection (FIG. 8).

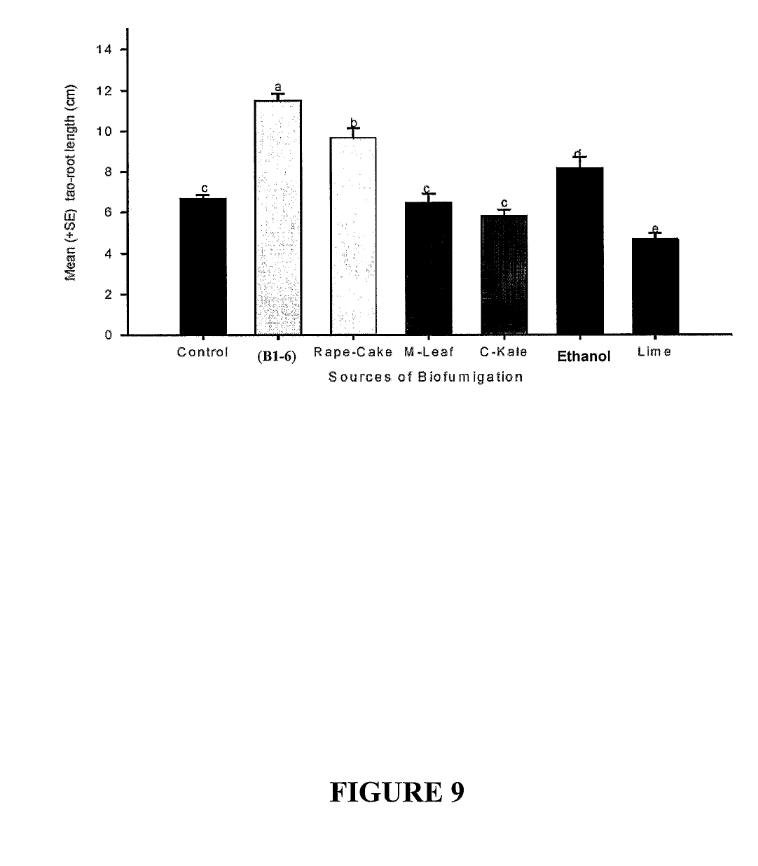

The length of tap root was measured for all treatments as an indicator of root health. Tap root length was significantly longer and had fibrous root content higher in pesticidal formulation (B1-6) treated pots compared to other treatments (FIG. 9).

Pesticidal formulation (B1-6) was the only treatment that was able to effectively control Club root and Soft Rot infections in the soil and thus would be an effective pre-treatment of plants and crops.

Those skilled in the art will appreciate that the invention described herein is susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

1. A pesticidal formulation comprising one or more phenols and one or more isothiocyanates.

2. The pesticidal formulation of claim 1 wherein weight ratio of phenol component(s) to isothiocyanate component(s) is in the range of about 1:95 to about 4:1.

3. The pesticidal formulation of claim 1 wherein weight ratio of phenol component(s) to isothiocyanate component(s) is in the range of about 1:4 to about 1:1.

4. The pesticidal formulation of claim 1 wherein weight ratio of phenol component(s) to isothiocyanate component(s) is in the range of about 1:2.3 to about 1:1.3

5. The pesticidal formulation of claim 1 wherein the phenolic component of the pesticidal formulation is a compound of formula I: 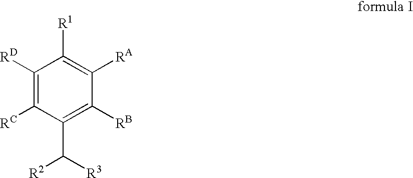
wherein:
R¹ is selected from hydrogen, hydroxide, C₁₋₆alkoxy or C₁₋₆alkyl, C₂₋₈alkenyl,
R^{A}, R^{B}, R^{C}C and R^{D} are independently selected from hydrogen, hydroxy, C₁₋₄alkoxy or C₁₋₄alkyl provided that at least one of R^{A} to R^{D} is hydroxy; and
R² and R³ are independently selected from hydrogen, C₁₋₆alkyl, C₁₋₆alkanoyl, or C₂₋₈alkenyl.

6. The pesticidal formulation of claim 5 wherein R¹, R² and R³ are methyl, R^{C} and R^{D} are hydrogen and R^{A} and R^{B} are independently selected from hydrogen or hydroxy.

7. The pesticidal formulation of claim 1 wherein the one or more isothiocyanate is a compound of formula II:
R⁴—N═C═S formula II
wherein:
R⁴ is selected from optionally substituted C₁₋₁₀alkyl, C₂₋₁₀alkenyl, aryl, and C₁₋₄alkylaryl.

8. The pesticidal formulation of any one of the preceding claims wherein the isothiocyanate is selected from a C₂₋₆alkenylisothiocyanate, C₂₋₆alkylisothiocyanate, arylisothiocyante, or benzylisothiocyanate.

9. The pesticidal formulation of claim 8 wherein the isothiocyanate is allylisothiocyanate.

10. The pesticidal formulation of claim 5 or claim 7, comprising 2-7% by weight of a phenol of formula I and 5-15% by weight of an isothiocyanate of formula II.

11. The pesticidal formulation of claim 5 or claim 7 containing 4-5% by weight of a phenol of formula I and 8-12% by weight of an isothiocyanate of formula II.

12. The pesticidal formulation of claim 1 wherein the one or more phenols are prepared synthetically.

13. The pesticidal formulation of claim 1 wherein the one or more phenols are derived from natural sources.

14. The pesticidal formulation of claim 1 wherein the one or more phenols of the pesticidal formulation are a phytochemical component of one or more plant extracts.

15. The pesticidal formulation of claim 1 wherein the plant extract is selected from oreganum sp. extract, carum copticum extract, clove oil; basil oil; cinnamon oil; savory oil; parsley oil; thymus sp. extract; boronia oil; bay oil; terpeneless bay oil; savory; cinnamon bark oil; pimenta berry oil; pimenta leaf oil; clove hull oil; clove stem oil; oak moss oil; oil of wintergreen and oil of birch.

16. The pesticidal formulation of claim 15 wherein the plant extract is an oreganum sp. extract.

17. The pesticidal formulation of claim 15 wherein the plant extract is oregano oil.

18. The pesticidal formulation of claim 15 wherein the plant extract is carum copticum extract.

19. The pesticidal formulation of claim 15 wherein the plant extract is ajowan oil.

20. The pesticidal formulation claim 1 wherein at least one of the one or more phenols is an anti-oxidant.

21. The pesticidal formulation of claim 1 further comprising a curcuminoid derivative.

22. The pesticidal formulation of claim 1 further comprising a curcuminoid derivative of formula V or a tautomer or a mixture of tautomers thereof: 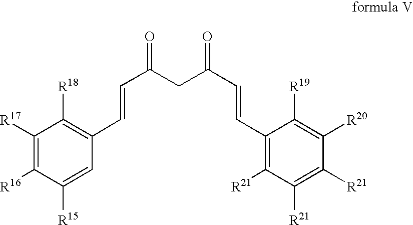
wherein;
R¹⁵ to R²¹ are independently selected from hydrogen, C₁₋₄alkoxy, and hydroxy.

23. The pesticidal formulation of 22 wherein the curcuminoid derivative is a phytochemical component of a plant extract.

24. The pesticidal formulation claim 23 wherein the curcuminoid derivative is provided in the form of an extract of a plant of the ginger family Zingiberaceae.

25. The pesticidal formulation of claim 23 wherein the curcuminoid derivative is provided in the form of an extract of Zingiberaceae Curcuma.

26. The pesticidal formulation of claim 23 wherein the curcuminoid derivative is provided in the form of an extract of Zingiberaceae Curcuma longa.

27. The pesticidal formulation of claim 23 wherein the curcuminoid derivative is provided in the form of tumeric oil.

28. The pesticidal formulation of either of claim 1 or claim 21 further comprising a compound of formula IV; 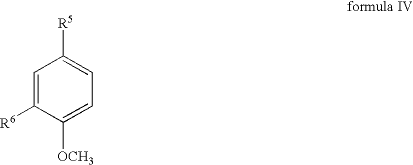
wherein:
R⁵ is selected from hydrogen, optionally substituted C₁₋₄alkyl, optionally substituted C₁₋₄alkenyl, optionally substituted C₁₋₄alkanoyl, carboxyl, or a C₁₋₄aldehyde; and
R⁵ is selected from hydrogen, optionally substituted C₁₋₄alkyl, optionally substituted C₁₋₄alkanoyl, carboxyl, or a C₁₋₄aldehyde;
provided that both R⁵ and R⁶ are not hydrogen.

29. The pesticidal formulation of claim 1 or 21 further comprising a plant extract selected from an aniseed, anise, star anise, tarragon, or fennel extract.

30. The pesticidal formulation of claim 1 in the form of a concentrate.

31. The pesticidal formulation of claim 1 further comprising a carrier.

32. The pesticidal formulation of claim 1 or 31 in a diluted ready to apply formulation.

33. The pesticidal formulation of claims 31 wherein the carrier is a carrier oil.

34. The pesticidal formulation of claim 31 wherein the carrier is a carrier oil and is selected from a canola oil, sesame oil, sunflower oil, a polyunsaturated vegetable oil, neem oil, karanj oil or a refined palm oil.

35. The pesticidal formulation of claim 1 further comprising one or more surfactants, activators; compatibility agents; dispersants; detergents; stabilisers; emulsifiers; wetting agents; spreading agents; sticking agents; foam suppressants; or drift suppressants.

36. The pesticidal formulation of claim 1 in the form of a solution, suspension, emulsion or cream.

37. The pesticidal formulation of claim 1 in the form of a soil pesticidal formulation.

38. The pesticidal formulation of any claim 1 in the form of a plant pesticidal formulation.

39. A pesticidal formulation comprising about 5% to about 25% by weight of oregano oil; about 10% to about 80% by weight of allyl isothiocyanate; about 5% to about 25% by weight of turmeric oil; about 5% to about 25% by weight of ajowan oil; and about 5% to about 25% by weight of star anise oil.

40. The pesticidal formulation of claims 39 comprising by weight about 5% oregano oil; about 10% allyl isothiocyanate; about 5% turmeric oil; about 5% ajowan oil; about 5% star anise oil, and about 70% canola oil.

41. A method of treating pest infestations, the method comprising applying a pesticidally amount of a formulation according to the invention, to a location in need of treatment for pest infestations.

42. Use of one or more phenols and one or more isothiocyanates in the manufacture of a pesticidal composition for treating pest infestations.
